(19) United States
(12) Patent Application Publication
(10) Pub. No.: US 2010/0217883 A1
(43) Pub. Date: Aug. 26, 2010

(54) Intelligent software agents for multiple platforms

(76) Inventor: Drew Goya, Los Angeles, CA (US)

Correspondence Address: Benman, Brown & Williams, Suite 2740, 2049 Century Park East, Los Angeles, CA, 90067, US

(21) Appl. No.: 12/378,944

(22) Filed: Feb. 20, 2009

(51) Int. Cl. G06F 15/16

(52) U.S. Cl. 709/230; 709/203

(57) ABSTRACT

A software agent system for multiple platforms. The novel system includes a first mechanism for storing a database of software agents, a second mechanism for transferring a software agent from a first client application on a first type of platform to the database, and a third mechanism for transferring the software agent from the database to a second client application on a second type of platform that is different from the first type of platform. The first client application uses a first communications protocol to communicate with the database, while the second client application uses a second communications protocol. In an illustrative embodiment, the software agents are virtual pets and the database is adapted to store a current state of each virtual pet, allowing a virtual pet to be transferred from a first client application to the database, and then from the database to a second client application.

### BACKGROUND OF THE INVENTION

1. Field of the Invention

The present invention relates to systems and methods for computing and communication. More specifically, the present invention relates to software agents.

2. Description of the Related Art

A software agent is a software entity that is capable of acting with a certain degree of autonomy and, in the case of an intelligent software agent, exhibits some artificial intelligence (e.g., having the ability to learn or adapt). For example, a virtual pet is a software agent programmed to interact with users and/or other software agents, to simulate the experience of owning a pet (which may be a traditional pet such as a cat or dog, a fictitious creature such as a dragon or monster, or a human character). A user may, for example, feed, groom, discipline, or play with a virtual pet, and the pet responds based on past interactions with the user and possibly random factors. A virtual pet typically has no physical form other than the hardware upon which its software is run, although it often has a graphical representation that may be displayed, for example, on a computer screen.

Virtual pets can be found on a variety of different platforms. Some virtual pets (such as “Tamagotchi”) exist in a self-contained, key-chain sized electronic toy with a small visual display and a few buttons that allow a user to interact with the pet. Virtual pet websites (such as “Neopets”) allow a user to have and interact with a pet within a virtual environment that is accessible through a web browser. Simple virtual pet games may be found in cellular phones, as Java applications or applications using a Wireless Application Protocol (WAP), Short Message Service (SMS), or some other mobile communications protocol. Other more complex virtual pet games may come in software applications that run on a personal computer or video game console (for example, “Petz”). Virtual pets may also be found within other types of games, such as in a massive multiplayer online game or MMOG (for example, “World of Warcraft”), in which the user controls a character in the game and that character can have a virtual pet that responds to interactions with the character and with other objects and events in the gaming environment.

A conventional virtual pet, however, typically cannot be transferred between different platforms. For example, a pet from a video game cannot be transferred to a cellular phone, or played with via a web browser, or summoned in a MMOG. Portability between platforms would allow a user to interact with his virtual pet in more settings, resulting in a potentially more entertaining and rewarding experience.

Hence, a need exists in the art for a system or method for transferring a virtual pet between different platforms.

### SUMMARY OF THE INVENTION

The need in the art is addressed by the software agent system for multiple platforms of the present invention. The novel system includes a first mechanism for storing a database of software agents, a second mechanism for transferring a software agent from a first client application on a first type of platform to the database, and a third mechanism for transferring the software agent from the database to a second client application on a second type of platform that is different from the first type of platform. The first client application uses a first communications protocol to communicate with the database, while the second client application uses a second communications protocol. In an illustrative embodiment, the software agents are virtual pets and the database is adapted to store a current state of each virtual pet, allowing a virtual pet to be transferred from a first client application to the database, and then from the database to a second client application.

### BRIEF DESCRIPTION OF THE DRAWINGS

FIG. 1 is a simplified diagram of a virtual pet system designed in accordance with an illustrative embodiment of the present invention.

FIG. 2 is a simplified flow diagram for a virtual pet server designed in accordance with an illustrative embodiment of the present invention.

FIG. 3 is a simplified flow diagram for periodic pet processing by a virtual pet server designed in accordance with an illustrative embodiment of the present invention.

FIG. 4 is a simplified diagram of a pet development tree designed in accordance with an illustrative embodiment of the present invention.

FIG. 5 is a simplified flow diagram of a client application designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention teaches a novel virtual pet system in which a virtual pet can be transferred between different platforms. A platform is defined as the hardware and/or software upon which a virtual pet client application is run (e.g., a personal computer, a video game console, a cellular phone, or a web browser). The client application provides a virtual pet handling space that allows a user to interact with his virtual pet(s) in a variety of different ways. In accordance with the present teachings, the virtual pet handling system is accessible through several different types of platforms, for example: a Java-based cellular phone application, a cellular phone web browser, a PC/Mac/Linux web browser, a Flash application, a stand-alone PC/Mac/Linux application, and/or a software addition/modification to a massive multiplayer online game (MMOG).

A transfer between platforms may be initiated by the user or may take place automatically (upon closing a client application, for example). The transfer copies the full state of the virtual pet, preserving the results of past interactions and random events. This allows the user to interact with the same virtual pet across several different platforms.

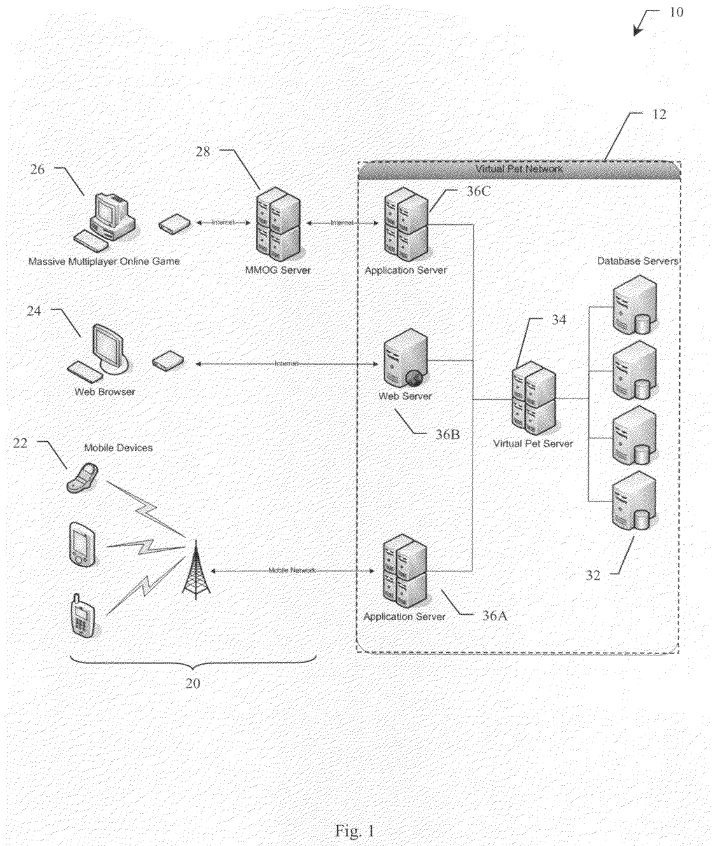

FIG. 1 is a simplified diagram of a virtual pet system 10 designed in accordance with an illustrative embodiment of the present invention. The novel system 10 includes a virtual pet server network 12 that stores the virtual pets in a database and interfaces with a plurality of client applications 20 on different types of platforms to upload and download information about selected virtual pets. The illustrative embodiment of FIG. 1 shows the following platforms: mobile electronic devices 22, such as a cellular phone, personal digital assistant (PDA), or portable game console, which communicate with the virtual pet network 12 via a mobile network; a web browser 24 on a personal computer that communicates with the virtual pet network, 12 via an internet connection; and an MMOG 26 running on a personal computer that interfaces with an MMOG server 28 via an internet connection and the MMOG server 28 communicates with the virtual pet network 12 via the internet.

In the illustrative embodiment, the virtual pet network 12 includes one or more database servers 32, a virtual pet server 34, and one or more application servers 36A, 36B, and 36C. The database servers 32 store a database of the virtual pets in the system 10. The database includes information about each virtual pet, including for example, its user's name or account information, its current state (which may include variables that represent the pet's type, health, mood, etc.), and a history of user/pet interactions, pet/pet interactions, and events. In an illustrative embodiment, every method of accessing the handling space (i.e., every client application on every platform) queries a common database for information about a pet's state and stores into the database the results of user/pet and pet/pet interactions.

The virtual pet server 34 handles communication with the database servers 32 (retrieving and storing data), and may also perform periodic processing on the virtual pets (described more fully below). The application servers 36 handle communication with the various client applications 20. The application servers 36 may also handle some virtual pet processing (e.g., pet responses to user interactions, pet development, random events, etc.). Alternatively, virtual pet processing may be handled by the client application 20, or processing may be divided between the client application 20, the application server 36, and the virtual pet server 34.

In accordance with the present teachings, the virtual pet network 12 is equipped to handle a variety of different communications protocols. Each type of client application 20 may use a different communications protocol and/or port. For example, an application for a cellular phone 22 may use a mobile communications protocol such as Short Message Service (SMS) or Wireless Application Protocol (WAP). A stand-alone computer application or MMOG may use the Internet Protocol Suite (commonly TCP/IP). A web-based application may use the Hypertext Transfer Protocol (HTTP).

In the illustrative embodiment, a separate application server 36 is set up to serve each type of client application 20 and/or communications protocol. Each application server 36 is adapted to receive/transmit and decode/encode data using a particular communications protocol. The client applications 20 are provided with information (e.g., IP addresses) so that they can connect with the appropriate application server 36. Alternatively, a single server may be designed to handle all types of clients and protocols by, for example, specifying a different port for each type of client. The entire virtual pet server network 12 may be implemented on a single server. Other implementations may also be used without departing from the scope of the present teachings.

In the illustrative embodiment of FIG. 1, the virtual pet network 12 includes three application servers: A mobile application server 36A is set up to receive queries from client applications on the mobile network, retrieve or store database information via the virtual pet server 34, and transmit virtual pet information to the client applications via the mobile network. For mobile devices, it may be preferable to perform virtual pet processing on the client side to save bandwidth, and use the mobile network to primarily download or upload a virtual pet's current state. A web server 36B handles queries from web-based client applications via the internet and communicates database information via the virtual pet server 34. The web server 36B may also be adapted to provide web page content, graphics, etc. to the web-based client applications, and may provide a virtual environment in which pets from different users can interact. An MMOG application server 36C handles queries from MMOG servers 28 and communicates database information on a user's character's virtual pet via the virtual pet server 34.

A separate application programming interface (API) may be provided for each type of client/platform. Each API and/or application server 36A, 36B, and 36C is tailored for each particular platform to handle client and platform specific issues such as communication and authentication protocols, firewalls and security, resource accessibility, etc. The virtual pet server 34 handles issues that are common to all platforms, such as retrieving/storing information from/in the database servers 32 and performing periodic virtual pet processing.

Thus, in accordance with the present teachings, the virtual pet system includes a common server or servers and a common database that can be accessed by a plurality of different client applications on different types of platforms, allowing a user to transfer a virtual pet between platforms (by uploading and downloading a virtual pet's current state from the database). Optionally, some client applications may also be set up to allow a direct transfer of a virtual pet, for example, transferring a pet from a cellular phone to a personal computer via a USB cable or Bluetooth connection.

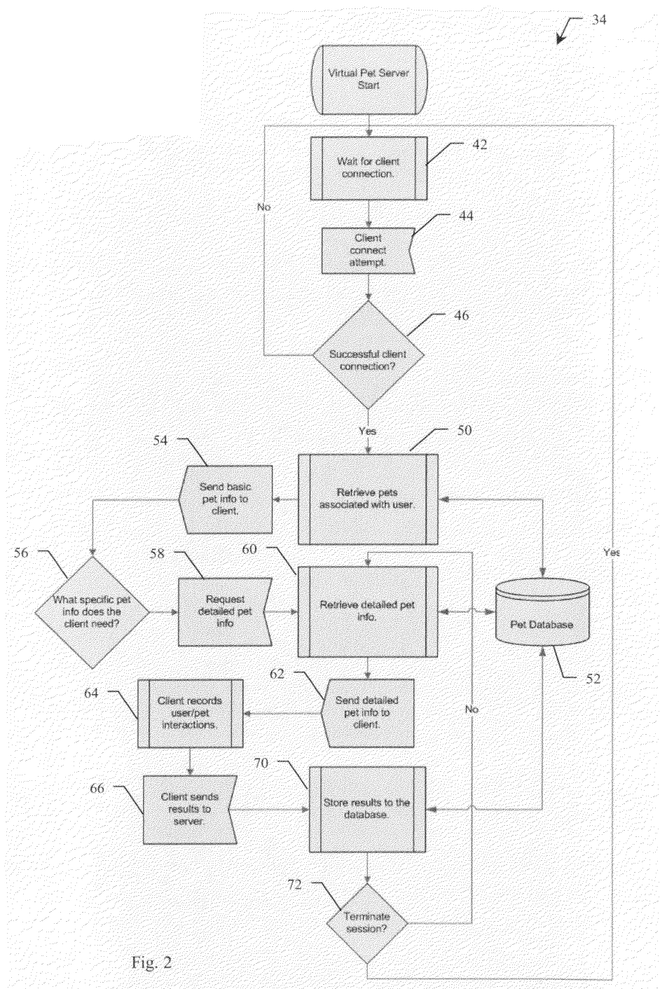

FIG. 2 is a simplified flow diagram for a virtual pet server 34 designed in accordance with an illustrative embodiment of the present invention. At Step 42, the virtual pet server 34 waits for a client connection from one of the application servers 36. At Step 44, a client application attempts to connect to the virtual pet server network 10. At Step 46, if the client connection is successful, continue to Step 50; otherwise, return to Step 42 and wait for another client connection. In the illustrative embodiment shown in FIG. 1 as described above, the details of the client connection are handled by the appropriate application server 36. If the connection is successful, the application server 36 sends a request to the virtual pet server 34 to retrieve any pets associated with the user.

At Step 50, the virtual pet server 34 retrieves basic information on the pet(s) associated with the user from the pet database 52 (stored in the database servers 32) and relays the data to the application server 36 (which requested the information). At Step 54, the application server 36 sends the basic pet information (which may include, for example, the names and types of pets associated with the user) to the client application. At Step 56, the client application asks the user to indicate which specific pet he would like to play with and requests more data on the selected pet from the virtual pet network 10. At Step 58, the application server 36 receives the request from the client application and requests the desired data from the virtual pet server 34.

At Step 60, the virtual pet server 34 retrieves detailed information on the selected pet from the pet database 52 and relays the data to the application server 36. At Step 62, the application server 36 sends the detailed pet information (including, for example, state data and interaction histories) to the client application. At Step 64, the client application receives the detailed pet information and displays the pet in a virtual pet handling space, where the user can interact with the pet and the client application records the user/pet interactions. At Step 66, when the user is finished playing with the pet, or if he requests to save the pet, the client application sends the results (the pet's current state and interaction history) to the virtual pet server 34 (via the application server 36).

At Step 70, the virtual pet server 34 stores the results to the pet database 52. At Step 72, if the session has been terminated, then return to Step 42 and wait for the next client connection; otherwise, return to Step 60.

The virtual pet server 34 may also be set up to perform periodic pet processing on the pets in the pet database. In a preferred embodiment, all virtual pets in the system are stored in the pet database and updated as users download pets and interact with them. The virtual pets are not stored in the client applications (except when they are being used). In this embodiment, it may be desirable to perform various processing on the virtual pets—such as updating their development or applying random events—while they are in the database instead of in the client applications.

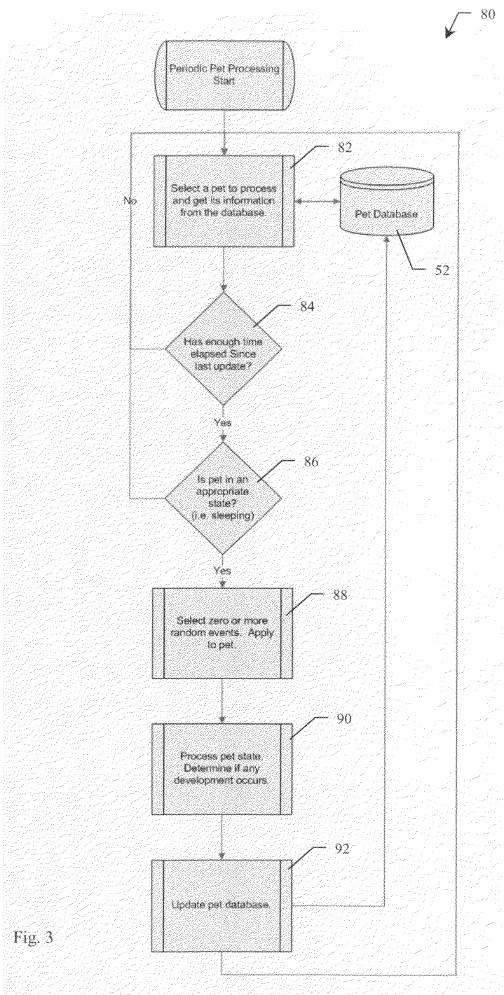

FIG. 3 is a simplified flow diagram for periodic pet processing 80 by a virtual pet server 34 designed in accordance with an illustrative embodiment of the present invention. First, at Step 82, the virtual pet server 34 selects a pet to process and retrieves its information from the pet database 52. At Step 84, the virtual pet server 34 determines if enough time (some predetermined amount) has elapsed since the last update (the time of the last update is stored in the database as part of the pet's data). If no, then return to Step 82 and select another pet; otherwise, at Step 86, the virtual pet server 34 determines if the pet is in an appropriate state (i.e., sleeping). If no, then return to Step 82 and select another pet; otherwise, continue to processing at Step 88.

Optionally, at Step 88, the virtual pet server 34 selects zero or more random events from a list of predetermined events and applies them to the pet. For example, random events may include finding an item, learning a new trick, or getting sick.

At Step 90, the virtual pet server 34 processes the pet state and determines if any development occurs (e.g., if the pet evolves into a new type of pet based on its user/pet and pet/pet interactions, as described below).

At Step 92, the pet database 52 is updated with the results of the pet processing. The virtual pet server 34 then returns to Step 82 to select the next pet for processing. This continues until each pet is processed. In an illustrative embodiment, the pet database is processed in this manner periodically, for example, once per day or week.

In an illustrative embodiment, each pet can develop into a number of new pets based on how a user interacts with it and/or how the pet interacts with other pets. The possibilities for pet development can be represented as a tree. At each node in the tree, there can be one or more branches. A pet advances down a branch and develops into a new pet once certain conditions are met. These conditions may include a combination of user/pet and pet/pet interactions as well as random events.

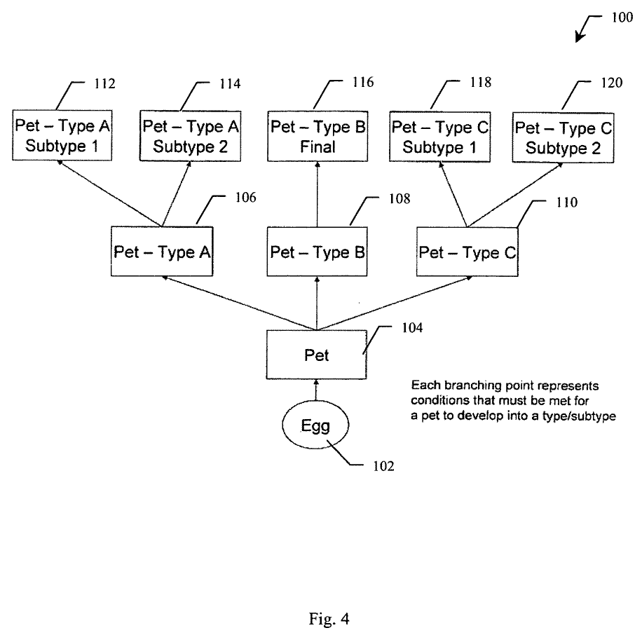

FIG. 4 is a simplified diagram of a pet development tree 100 designed in accordance with an illustrative embodiment of the present invention. A virtual pet starts as an egg 102 that develops into a particular type of pet 104. In the illustrative embodiment, the pet 104 can then develop into one of three types of pets, labeled pet type A 106, pet type B 108, and pet type C 110. From each of these types, the pet can develop further into a particular subtype. In the example of FIG. 4, pet type A 106 can develop into a pet subtype A1 112 or pet subtype A2 114. Pet type B 108 can develop into a type B final 116. Pet type C can develop into a pet subtype C1 118 or pet subtype C2 120. Each branching point in the tree represents the conditions that must be met for a pet to develop into a type or subtype.

The system may include several different pet development trees. For each different tree, the pet starts as a different type of egg. Pet development may be handled by the virtual pet server 34 (at Step 90 in the embodiment of FIG. 3), the client application, or both.

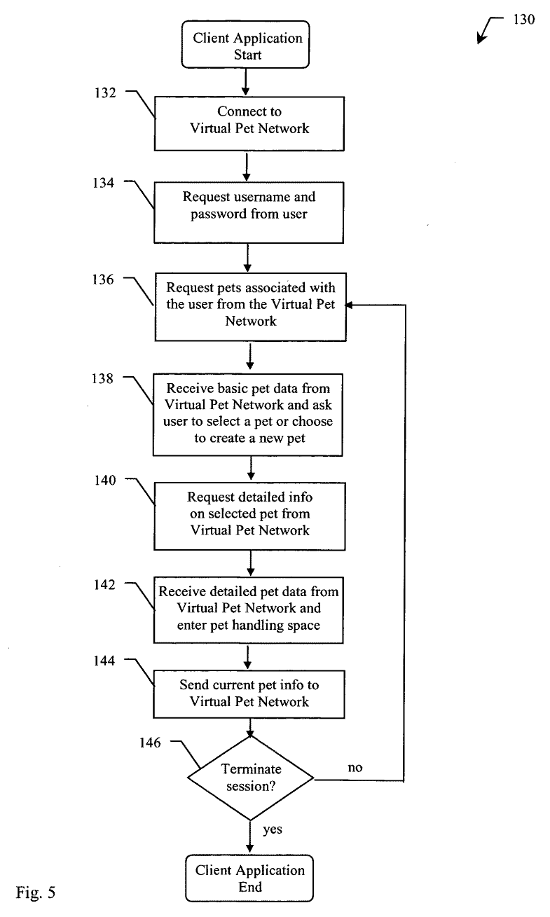

FIG. 5 is a simplified flow diagram of a client application 130 designed in accordance with an illustrative embodiment of the present invention. After a user starts the client application 130, at Step 132 the client application 130 connects to the virtual pet network 12 (connecting to the appropriate application server 36 in the embodiment of FIG. 1). After a successful connect, at Step 134 the client application 130 requests and obtains a username or other identification from the user. At Step 136, the client application 130 requests basic information on the pet(s) associated with the user from the virtual pet network 12. At Step 138, the client application 130 receives the basic pet data and asks the user to select a pet (or create/obtain a new pet). At Step 140, the client application 130 requests detailed data on the selected pet from the virtual pet network 12. At Step 142, the client application 130 receives the detailed pet data and displays the pet in the virtual pet handling space. When the user is finished playing with his pet, at Step 144 the client application 130 sends the current pet state data to the virtual pet network 12 and stores the data in the pet database. At Step 146, if the user wants to continue playing, return to Step 136 and allow the user to select another pet; otherwise, terminate the session and close the application.

The handling space allows the user to interact with the pet. This interaction may include feeding (with a choice of healthy food, junk food, medicine, vitamins, etc.), discipline, grooming, free play (toys, exercise), games (quests, adventures), and outfit customization. Optionally, users may be able to put two or pets in the same handling space and let them interact. This interaction is driven by each pet's current state and possible random factors. As stated above, these user/pet and pet/pet interactions affect which development paths a pet takes and what type of behaviors it will exhibit. The handling space may also include a save feature, allowing a user to save the pet's current state to the virtual pet network 12 while in the middle of a game.

In the virtual pet system of the present invention, client applications from several different types of platforms interface with a common virtual pet network to access a common pet database, allowing a user to transfer a virtual pet between platforms while preserving the pet's current state and the results of past interactions and events. The client applications, however, may differ between different platforms. For example, the client applications may include a variety of stand-alone computer/video games, each game featuring a different quest or adventure. Some client applications may provide an environment allowing multiple pets from multiple users to interact, while other client applications may be set up for only one pet from one user. A client application may also allow users to trade their virtual pets, recording the pets' new owners into the pet database.

As stated earlier, the client applications may include an addition or modification to an MMOG, allowing a user to import his pet into an online gaming environment. In an illustrative MMOG embodiment, each pet is linked to a user's MMOG account or character. This link provides the character (or all characters on the user account) with an item which can be equipped or used (right clicked, clicked, or otherwise interacted with) or a spell/ability which summons an in-game entity that represents the virtual pet. This entity reflects the pet's current state (as obtained from the virtual pet network), including for example, what type of pet it has developed into, what it is wearing, how it is feeling (mad, sad, hungry, happy, etc.). The entity follows the character in the MMOG environment and may periodically pick from a set of animations to execute (which may be chosen based in part on the pet's current state). The virtual pet entity may be able to provide the user's character with game related benefits based on its current state (e.g., more hit points, do 1% more damage, etc.). The entity may also be able to participate in combat on the character's behalf.

The following is an example scenario for a virtual pet system designed in accordance with the present teachings: First, a user downloads a virtual pet onto his cellular phone through his wireless provider's network. He launches a Java-based client application on the phone, plays with the virtual pet for an hour, and then closes the application. As the application shuts down, it uploads the virtual pet's current state to the virtual pet network.

The user then sits down at his computer and launches an MMOG. As the MMOG starts up, it requests the virtual pet's current state from the virtual pet network. The user logs in to the MMOG and plays with the virtual pet in a persistent online environment. Other people playing the same MMOG can see the virtual pet and the user can let them interact with it as well. When the user logs off, the MMOG uploads the virtual pet's current state to the virtual pet network.

Some time later, the user launches a stand-alone application on his computer that allows him to play with his virtual pet. As the application starts up, it requests the virtual pet's current state from the virtual pet network. The user plays with the pet for an hour and decides to transfer the pet to his phone. The user connects his phone to the computer with a USB cable and transfers the virtual pet. He launches a Java application on the phone and is able to play the virtual pet that “remembers” what happened while the user was playing with it on his computer. When the user shuts down the application on the phone, it uploads the virtual pet's current state to the virtual pet network.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system comprising:
first means for storing a database of software agents;
second means for transferring a software agent from a first client application on a first type of platform to said database; and
third means for transferring said software agent from said database to a second client application on a second type of platform, wherein said second type of platform is different from said first type of platform.

2. The invention of claim 1 wherein said second means includes means for handling client specific issues for said first client application.

3. The invention of claim 2 wherein said third means includes means for handling client specific issues for said second client application, wherein said client specific issues are handled differently for said second client application than said first client application.

4. The invention of claim 1 wherein said second means includes means for communicating with said first client application using a first communications protocol.

5. The invention of claim 4 wherein said third means includes means for communicating with said second client application using a second communications protocol that is different from said first communications protocol.

6. The invention of claim 5 wherein said first communications protocol is a mobile communications protocol.

7. The invention of claim 6 wherein said second communications protocol is an internet protocol.

8. The invention of claim 1 wherein said first type of platform includes a mobile device.

9. The invention of claim 1 wherein said first type of platform includes a cellular phone.

10. The invention of claim 8 wherein said second type of platform includes a personal computer.

11. The invention of claim 8 wherein said second type of platform includes a web browser.

12. The invention of claim 8 wherein said second type of platform includes a massive multiplayer online game server.

13. The invention of claim 8 wherein said second type of platform includes a video game console.

14. The invention of claim 1 wherein said system further includes means for communicating between said database and one or more additional types of client applications.

15. The invention of claim 1 wherein said second means includes a first application server.

16. The invention of claim 15 wherein said third means includes a second application server.

17. The invention of claim 16 wherein said first means includes one or more database servers.

18. The invention of claim 17 wherein said system further includes an intermediate server adapted to handle communication between said application servers and said database servers.

19. The invention of claim 18 wherein said intermediate server is also adapted to perform periodic processing on said database of software agents.

20. The invention of claim 19 wherein said periodic processing includes applying random events to said software agents in said database.

21. The invention of claim 19 wherein said periodic processing includes updating said software agents in said database in accordance with one or more development trees.

22. The invention of claim 1 wherein said database is adapted to store a current state of each software agent.

23. The invention of claim 22 wherein said second and third means are adapted to upload state data from said client applications to said database and to download state data from said database to said client applications.

24. The invention of claim 1 wherein said software agents are virtual pets.

25. A virtual pet network comprising:
one or more database servers adapted to store a database of virtual pets;
a first application server adapted to use a first communications protocol to communicate with one or more first client applications and transfer virtual pet state data between said database and said first client applications; and
a second application server adapted to use a second communications protocol to communicate with one or more second client applications and transfer virtual pet state data between said database and said second client applications, wherein said second communications protocol is different from said first communications protocol.

26. A virtual pet system comprising:
a first client application on a first type of platform for allowing a user to interact with a virtual pet;
a second client application on a second type of platform for allowing a user to interact with a virtual pet; and
a virtual pet network adapted to communicate with said first and second client applications using first and second communications protocols, respectively, wherein said second communications protocol is different from said first communications protocol, and transfer current state data on a virtual pet from said first client application to a database stored in said virtual pet network and from said database to said second client application.

27. The invention of claim 26 wherein said virtual pet network includes one or more database servers for storing a plurality of virtual pets in said database.

28. The invention of claim 27 wherein said virtual pet network further includes a first application server adapted to communicate with said first client application using a first communications protocol and upload current state data on a virtual pet from said first client application to said database.

29. The invention of claim 28 wherein said virtual pet network further includes a second application server adapted to communicate with said second client application using a second communications protocol and download said state data on said virtual pet from said database to said second client application.

30. The invention of claim 29 wherein said system further includes a virtual pet server adapted to handle communication between said application servers and said database servers.

31. The invention of claim 30 wherein said virtual pet server is also adapted to perform periodic processing on said virtual pets stored in said database.

32. The invention of claim 31 wherein said periodic processing includes applying random events to said virtual pets.

33. The invention of claim 31 wherein said periodic processing includes updating said virtual pets in accordance with one or more development trees.

34. A method for transferring a virtual pet across different platforms including the steps of:
establishing a communications connection between a first client application on a first platform and a virtual pet network using a first communications protocol;
uploading virtual pet data from said first client application to said virtual pet network;
storing said virtual pet data in a database of said virtual pet network;
establishing a communications connection between a second client application on a second platform and said virtual pet network using a second communications protocol; and
downloading said virtual pet data from said database to said second client application.
